(19) United States
(12) Patent Application Publication
(10) Pub. No.: US 2023/0317945 A1
(43) Pub. Date: Oct. 5, 2023

(54) POSITIVE ELECTRODE ACTIVE MATERIAL, POSITIVE ELECTRODE AND FLUORIDE ION SECONDARY BATTERY

(71) Applicant: HONDA MOTOR CO., LTD., Tokyo (JP)

(72) Inventor: Kazuyuki SATO, (US)

(21) Appl. No.: 18/179,392

(22) Filed: Mar. 7, 2023

(30) Foreign Application Priority Data
Mar. 29, 2022 (JP) 2022-053257

(51) Int. Cl. H01M 4/58; H01M 4/36; C01F 11/22

(52) U.S. Cl. CPC H01M 4/582; H01M 4/364; C01F 11/22; H01M 2004/028

(57) ABSTRACT

Provided is a positive electrode active material including a fluoride composite material including a composite of copper and a fluoride represented by the formula:

BaₓCa₁₋ₓF₂

wherein x is 0.2 or more and 0.8 or less.

This application is based on and claims the benefit of priority from Japanese Patent Application No. 2022-053257, filed on 29 Mar. 2022, the content of which is incorporated herein by reference.

### BACKGROUND OF THE INVENTION

### Field of the Invention

The present invention relates to a positive electrode active material, a positive electrode, and a fluoride-ion secondary battery.

### Related Art

In recent years, secondary batteries that contribute to energy efficiency have been researched and developed to ensure that more people have access to affordable, reliable, sustainable, and advanced energy.

A fluoride-ion secondary battery, known as a solid-state battery, includes a positive electrode, a negative electrode, and a solid electrolyte layer disposed between the positive and negative electrodes. A known positive electrode active material for such a fluoride-ion secondary battery includes a fluoride composite material that is a composite of a metal and a fluoride-ion-conducting fluoride (see, for example, Patent Document 1).
Patent Document 1: PCT International Publication No. WO2019/187942

### SUMMARY OF THE INVENTION

There is, however, a need to improve the charge-discharge capacity of fluoride-ion secondary batteries.

It is an object of the present invention to provide a positive electrode active material that provides an increased charge-discharge capacity for fluoride-ion secondary batteries.

An aspect of the present invention is directed to a positive electrode active material including a fluoride composite material including a composite of copper and a fluoride represented by the formula:

BaₓCa₁₋ₓF₂

wherein x is 0.2 or more and 0.8 or less.

The fluoride composite material may be a product produced by an aerosol process.

Another aspect of the present invention is directed to a positive electrode including the positive electrode active material defined above.

A further aspect of the present invention is directed to a fluoride-ion secondary battery including the positive electrode defined above.

The present invention provides a positive electrode active material that provides an increased charge-discharge capacity for fluoride-ion secondary batteries.

### BRIEF DESCRIPTION OF THE DRAWINGS

FIG. 1 is a graph showing the results of measurement of the fluoride-ion conductivity of the fluoride composite materials of Examples 1 to 3 and Comparative Examples 1 and 2;

FIG. 2 is a chart showing the XRD (X-ray diffraction) spectrum of the fluoride composite material of Example 1;

FIGS. 3A, 3B, and 3C are respectively a BF-STEM (bright field-scanning transmission electron microscopy) image, ADF-STEM (annular dark field-scanning transmission electron microscopy) image, and EELS (electron energy loss spectroscopy) mapping image of a thin piece of the fluoride composite material of Example 1; and

FIG. 4 is a graph showing the second cycle charge-discharge curves of the fluoride-ion secondary battery cells of Example 1 and Comparative Example 1.

### DETAILED DESCRIPTION OF THE INVENTION

Hereinafter, embodiments of the present invention will be described.

### Positive Electrode Active Material

The positive electrode active material according to an embodiment of the present invention is a fluoride composite material that is a composite of copper and a fluoride represented by the formula:

BaₓCa₁₋ₓF₂

wherein x is 0.2 or more and 0.8 or less. The positive electrode active material with this feature according to an embodiment of the present invention has increased fluoride-ion conductivity. Thus, the positive electrode active material according to an embodiment of the present invention is suitable for use in forming a fluoride-ion secondary battery with an increased charge-discharge capacity.

In the formula, x is 0.2 or more and 0.8 or less and preferably 0.4 or more and 0.6 or less.

The content of copper in the positive electrode active material according to an embodiment of the present invention is preferably 40 at % or more and 70 at % or less and more preferably 50 at % or more and 60 at % or less. The positive electrode active material with a copper content of 40 at % or more and 70 at % or less according to an embodiment of the present invention is suitable for use in forming a fluoride-ion secondary battery with an increased charge-discharge capacity.

The positive electrode active material according to an embodiment of the present invention is preferably in the form of particles with an average particle size of 35 nm or less, more preferably in the form of particles with an average particle size of 25 nm or less. The positive electrode active material in the form of particles with an average particle size of 35 nm or less according to an embodiment of the present invention has an increased effective area capable of contributing to electrode reactions. Thus, the positive electrode active material according to an embodiment of the present invention is suitable for use in forming a fluoride-ion secondary battery that has improved temperature characteristics of charge-discharge capacity and operates satisfactorily even in a low-temperature environment. The average particle size of the positive electrode active material according to an embodiment of the present invention is typically, but not limited to, 20 nm or more.

As used herein, the term “average particle size” means the average of primary particle sizes that is calculated from their specific surface area determined by constant volume gas adsorption method.

The positive electrode active material according to an embodiment of the present invention may be produced by an aerosol process. The aerosol process includes, for example, melting copper and a fluoride represented by the formula:

BaₓCa₁₋ₓF₂

wherein x is 0.2 or more and 0.8 or less and then spraying the resulting molten material under reduced pressure.

### Positive Electrode

The positive electrode according to an embodiment of the present invention includes the positive electrode active material according to an embodiment of the present invention. For example, the positive electrode according to an embodiment of the present invention may include a positive electrode current collector; and a positive electrode material mixture layer disposed on the current collector. The positive electrode material mixture layer includes the positive electrode active material according to an embodiment of the present invention and, if necessary, may further include any other positive electrode active material than that according to an embodiment of the present invention, a solid electrolyte, a conductive aid, and other optional materials.

The positive electrode current collector may be any suitable electronically conductive material, such as a gold foil. The solid electrolyte may be any suitable fluoride-ion-conducting material, such as PbSnF₄. The conductive aid may be any suitable electronically conductive material, such as acetylene black.

The positive electrode according to an embodiment of the present invention may have a porous structure. The porous structure provides increased electrochemical reaction efficiency for fluoride-ion secondary batteries.

For example, the positive electrode according to an embodiment of the present invention is obtained by molding a powder composition including: the positive electrode active material according to an embodiment of the present invention; the solid electrolyte; and the conductive aid.

### Fluoride-Ion Secondary Battery

The fluoride-ion secondary battery according to an embodiment of the present invention includes the positive electrode according to an embodiment of the present invention. For example, the fluoride-ion secondary battery according to an embodiment of the present invention may include the positive electrode according to an embodiment of the present invention; a negative electrode; and a solid electrolyte layer disposed between the positive and negative electrodes.

The negative electrode includes, for example, a negative electrode current collector; and a negative electrode material mixture layer disposed on the current collector. The negative electrode material mixture layer includes a negative electrode active material and, if necessary, may further include a solid electrolyte, a conductive aid, and other optional materials.

The negative electrode current collector may be any suitable electronically conductive material, such as a gold foil. The negative electrode active material may be any suitable material, such as lead. The solid electrolyte may be any suitable fluoride-ion-conducting material, such as PbSnF₄. The conductive aid may be any suitable electronically conductive material, such as acetylene black.

Alternatively, the negative electrode may include a lead foil, which serves as both a negative electrode current collector and a negative electrode active material.

The solid electrolyte constituting the solid electrolyte layer may be any suitable fluoride-ion-conducting material, such as PbSnF₄.

The fluoride-ion secondary battery according to an embodiment of the present invention may be obtained, for example, by a process including: stacking, in order, a positive electrode-forming material(s) (e.g., a positive electrode current collector and a powder composition for forming a positive electrode material mixture layer), a solid electrolyte-forming material, and a negative electrode-forming material(s) (e.g., a negative electrode current collector and a powder composition for forming a negative electrode material mixture layer); and then integrally molding the resulting stack.

The embodiments of the present invention described above are not intended to limit the present invention and may be altered or modified as appropriate without departing from the gist of the present invention.

### EXAMPLES

Hereinafter, the present invention will be described with reference to examples, which are not intended to limit the present invention.

### Example 1

Copper particles with an average particle size of 1 μm (manufactured by Kojundo Chemical Lab. Co., Ltd.), barium fluoride (manufactured by Kojundo Chemical Lab. Co., Ltd.), and calcium fluoride (manufactured by Kojundo Chemical Lab. Co., Ltd.) were weighed in a mass ratio of 90:7:3 and then premixed using an agate mortar and an agate pestle for about 1 hour to form a raw material mixture powder.

In order to prevent the fluorides from absorbing moisture and prevent copper from oxidizing, the raw materials were weighed and premixed in a purge-type (DBO-type) glove box (manufactured by Miwa Mfg Co., Ltd.).

The resulting raw material mixture powder was classified using a stainless steel mesh with an aperture of 500 μm. Subsequently, the fraction of the raw material mixture powder remaining on the mesh was subjected to mixing using an agate mortar and an agate pestle and then subjected to the classification. This process was performed until no raw material mixture powder remained on the mesh.

After the classification, the raw material mixture powder was enclosed in a gas-tight powder hopper, which was then removed from the glove box and connected to a radio-frequency induction thermal plasma nanoparticle synthesizer TP-40020NPS (manufactured by JEOL Ltd.). Next, while argon gas was supplied to the plasma torch, the raw material mixture powder was melted by the thermal plasma to form a molten raw material, which was sprayed into the chamber under reduced pressure. After being sprayed into the chamber, the molten raw material was cooled to form nanoparticles of a fluoride composite material (Cu—Ba_{0.5}Ca_{0.5}F₂). Subsequently, the fluoride composite material particles were collected using an exhaust filter and then transported into a glove box using valves to shut off flow upstream and downstream of the exhaust filter, so that the collection of the fluoride composite material was completed.

### Example 2

A fluoride composite material was obtained as in Example 1 except that barium fluoride (manufactured by Kojundo Chemical Lab. Co., Ltd.) and calcium fluoride (manufactured by Kojundo Chemical Lab. Co., Ltd.) were weighed such that Cu—Ba_{0.8}Ca_{0.2}F₂ would be formed as the fluoride composite material.

### Example 3

A fluoride composite material was obtained as in Example 1 except that barium fluoride (manufactured by Kojundo Chemical Lab. Co., Ltd.) and calcium fluoride (manufactured by Kojundo Chemical Lab. Co., Ltd.) were weighed such that Cu—Ba_{0.2}Ca_{0.8}F₂ would be formed as the fluoride composite material.

### Comparative Example 1

A fluoride composite material was obtained as in Example 1 except that barium fluoride (manufactured by Kojundo Chemical Lab. Co., Ltd.) and calcium fluoride (manufactured by Kojundo Chemical Lab. Co., Ltd.) were weighed such that Cu—BaF₂ would be formed as the fluoride composite material.

### Comparative Example 2

A fluoride composite material was obtained as in Example 1 except that barium fluoride (manufactured by Kojundo Chemical Lab. Co., Ltd.) and calcium fluoride (manufactured by Kojundo Chemical Lab. Co., Ltd.) were weighed such that Cu—CaF₂ would be formed as the fluoride composite material.

### Fluoride-Ion Conductivity

The fluoride composite material powder was compression-molded at 4 t/cm² to form a green pellet. The green pellet with a gold foil (current collector) disposed on each surface thereof was subjected to the measurement of fluoride-ion conductivity by AC (alternating current) impedance method.

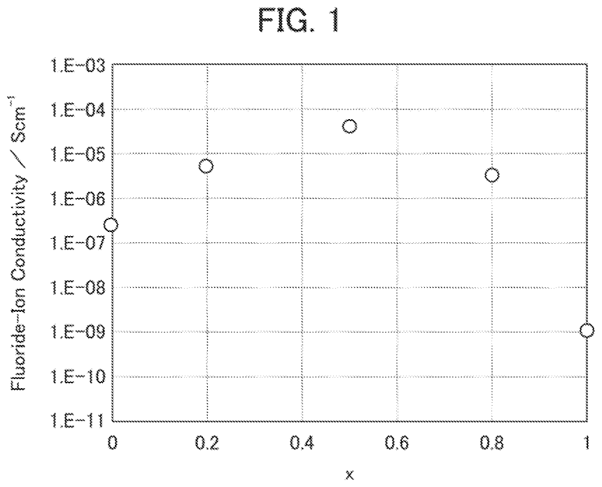

FIG. 1 shows the results of the measurement of the fluoride-ion conductivity of the fluoride composite materials of Examples 1 to 3 and Comparative Examples 1 and 2.

FIG. 1 indicates that the fluoride composite materials of Examples 1 to 3 each have a higher fluoride-ion conductivity than the fluoride composite material of Comparative Example 1 or 2.

### Crystal Structure

The crystal structure of the fluoride composite material of Example 1 was analyzed using a fully automatic multipurpose X-ray diffractometer SmartLab (manufactured by Rigaku Corporation, Cu-Kα source, λ=1.5418 Å).

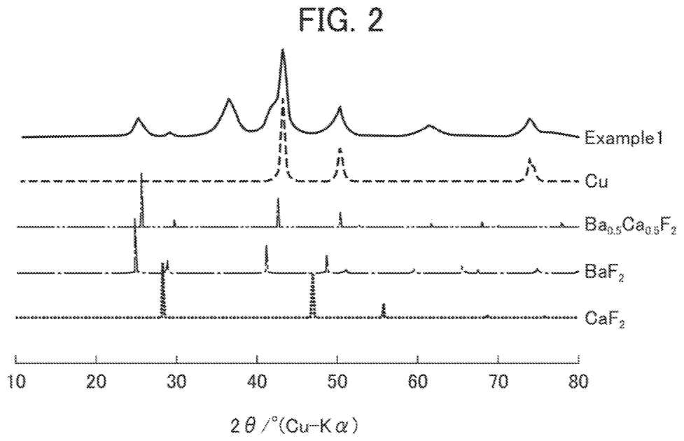

FIG. 2 shows the XRD spectrum of the fluoride composite material of Example 1. FIG. 2 also shows the XRD spectra of Cu, Ba_{0.5}Ca_{0.5}F₂, BaF₂, and CaF₂.

FIG. 2 reveals that the fluoride composite material of Example 1 with a peak at approximately 35° has a crystal structure different from that of Cu, Ba_{0.5}Ca_{0.5}F₂, BaF₂, or CaF₂.

### Domain Structure

The fluoride composite material of Example 1 was processed into a thin piece using a focused ion beam (FIB) processing and observation system FB-2100 (manufactured by Hitachi High-Technologies Corporation, non-open air, cooled) and a precision ion polishing system Model 695 PIPS II (manufactured by Gatan Inc., non-open air, cooled).

The domain structure of the thin piece of the fluoride composite material of Example 1 was observed using an atomic resolution analytical electron microscope JEM-ARM200F NEOARM (manufactured by JEOL Ltd., non-open-air, cooled) and a CCD camera GIF Quantum-ER (for EELS) (manufactured by Gatan Inc.).

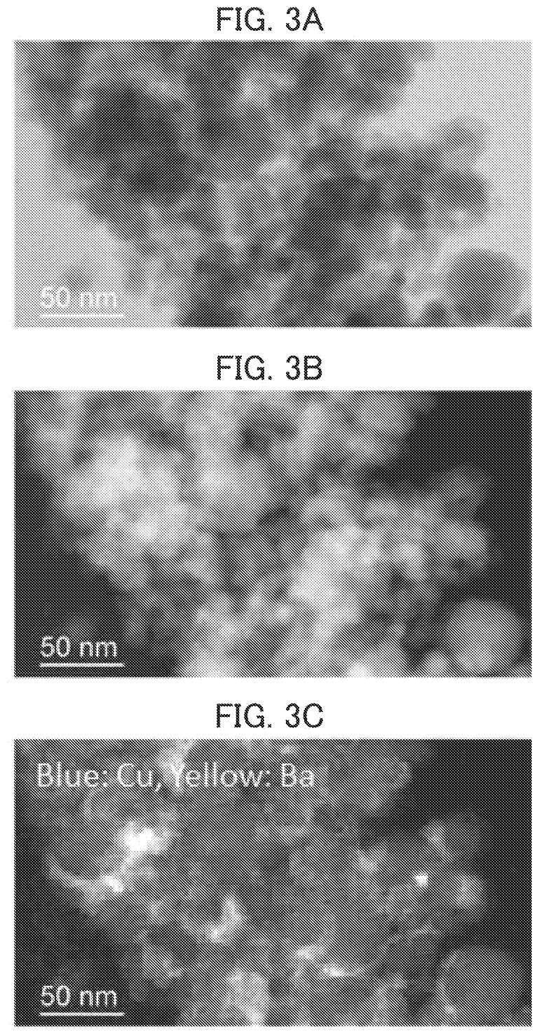

FIGS. 3A, 3B, and 3C show the BF-STEM image (see FIG. 3A), ADF-STEM image (see FIG. 3B), and EELS mapping image (see FIG. 3C) of the thin piece of the fluoride composite material of Example 1. The EELS mapping image includes Cu mapping (blue) and Ba mapping (yellow).

FIGS. 3A, 3B, and 3C reveal that the fluoride composite material of Example 1 has a Cu-containing domain and a Ba-containing domain.

### Preparation of Fluoride-Ion Secondary Batteries

Fluoride-ion secondary batteries were prepared using the fluoride composite material of Example 1 and the fluoride composite material of Comparative Example 1.

### Solid Electrolyte

PbSnF₄ was used as a solid electrolyte.

Positive Electrode Current collector

A gold foil was used as a positive electrode current collector.

### Powder Composition for Forming Positive Electrode Material Mixture Layer

The fluoride composite material (positive electrode active material), PbSnF₄ (solid electrolyte), and acetylene black (conductive aid, manufactured by Denka Company Limited) were weighed in a mass ratio of 30:65:5 and then thoroughly mixed to form a powder composition for forming a positive electrode material mixture layer.

### Negative Electrode

A 200 μm-thick lead foil (manufactured by Niraco) for serving as both a negative electrode current collector and a negative electrode active material was worked into a 10 mm-diameter piece, which was used as a negative electrode.

### Cell

The positive electrode current collector, the powder composition for forming a positive electrode material mixture layer (20 mg), the solid electrolyte (400 mg), and the negative electrode were stacked in order in a 10 mm-diameter mold and then integrally molded at a pressure of 4 t/cm² to form a fluoride-ion secondary battery cell. In this case, a gold wire was bonded with carbon paste to each of the surfaces of the positive electrode current collector and the negative electrode of the cell. The gold wires were used as terminals for the measurement of the charge-discharge characteristics.

### Charge-Discharge Capacity

Each of the fluoride-ion secondary battery cells was subjected to a constant current charge-discharge test at 140° C. Specifically, the constant current charge-discharge test was carried out using a potentio-galvanostat SI 1287/1255B (manufactured by Solartron) under the conditions of a charge and discharge current of 40 pA, a charge end voltage of 1.3 V (vs Pb/PbF₂), and a discharge end voltage of 0.3 V. The cell was placed in a compact environmental test chamber SU261 (manufactured by Espec Corporation) for controlling the temperature of the cell during the charging and discharging and subjected to the constant current charge-discharge test.

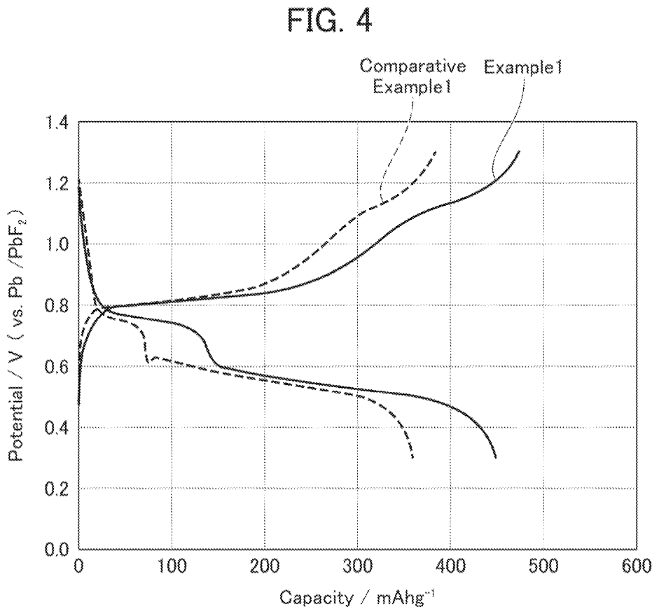

FIG. 4 shows the second cycle charge-discharge curves of the fluoride-ion secondary battery cells of Example 1 and Comparative Example 1. In FIG. 4, the horizontal axis represents capacity per g of the fluoride composite material.

FIG. 4 reveals that the charge-discharge capacity of the fluoride-ion secondary battery cell of Example 1 is higher than that of the fluoride-ion secondary battery cell of Comparative Example 1. This is probably because the fluoride-ion conductivity of the positive electrode active material of Example 1 is higher than that of the positive electrode active material of Comparative Example 1 (see FIG. 1).

What is claimed is:

1. A positive electrode active material comprising a fluoride composite material comprising a composite of copper and a fluoride represented by the formula:
BaₓCa₁₋ₓF₂
wherein x is 0.2 or more and 0.8 or less.

2. The positive electrode active material according to claim 1, wherein the fluoride composite material is a product produced by an aerosol process.

3. A positive electrode comprising the positive electrode active material according to claim 1.

4. A fluoride-ion secondary battery comprising the positive electrode according to claim 3.
